(19) United States
(12) Patent Application Publication
(10) Pub. No.: US 2015/0174873 A1
(43) Pub. Date: Jun. 25, 2015

(54) METHOD FOR ALIGNING COMPOSITE AND APPARATUS THEREFOR

(71) Applicants: Eunhee Shin, Daegu (KR); Susung Lee, Yongin-si (KR); Byungkuk Bae, Daegu (KR); Sunghag Kim, Daegu (KR)

(72) Inventors: Eunhee Shin, Daegu (KR); Susung Lee, Yongin-si (KR); Byungkuk Bae, Daegu (KR); Sunghag Kim, Daegu (KR)

(73) Assignee: ALPINION MEDICAL SYSTEMS CO., LTD., Hwaseong-si, Gyeonggi-do (KR)

(21) Appl. No.: 14/420,272

(22) PCT Filed: Aug. 8, 2012
(86) PCT No.: PCT/KR2012/006291

§ 371 Date: Feb. 6, 2015

(51) Int. Cl. B32B 37/00; B32B 3/30; B32B 38/00; B32B 7/12; B32B 37/12; B32B 37/16

(52) U.S. Cl. CPC B32B 37/0007; B32B 37/1284; B32B 37/16; B32B 38/0004; B32B 38/0012; B32B 37/0046; B32B 7/12; B32B 3/30; B32B 2038/0016; B32B 2307/20; B32B 2307/202; B32B 2309/00; B32B 2363/00; B32B 2038/0076

(57) ABSTRACT

At least one embodiment of the present disclosure provides a method for manufacturing a composite. The composite manufacturing comprises dicing a first material to provide a first slab having multiple posts, at least one alignment post, and multiple kerfs; dicing a second material to provide a second slab having multiple posts and multiple kerfs; coupling the first and second slabs so that they are intermeshed; and filling a kerf material in between each of the posts of the first slab and corresponding one of the posts of the second slab, wherein the alignment post is disposed on both edges or one of the edges of the first slab in a direction along which the posts and the kerfs are arranged, and is wider than each of the posts of the first slab such that the alignment post fits with a corresponding kerf of the second slab.

### TECHNICAL FIELD

The present disclosure relates to a method and an apparatus for aligning composites, and more particularly, to a method and an apparatus for aligning a pair of piezoelectric members in an interdigital pair bonding method that is one of the composite manufacturing processes.

### BACKGROUND

The statements in this section merely provide background information related to the present disclosure and do not constitute prior art.

A piezoelectric member utilizes a material that generates electrical charges by producing an electrical polarization in response to a mechanical stress. In other words, the piezoelectric member is a material that converts mechanical energy into electrical energy or vice versa.

A piezo-composite includes polymer material as a matrix and piezoelectric ceramic as a filler in order to compensate for a drawback of a conventional piezoelectric ceramic, which is used as a material for a ultrasonic transducer employed in various fields such as a sonar for underwater communication and detection, a non-destructive inspection, and a medical diagnostic apparatus.

A method for manufacturing the piezo-composite includes a dice and fill method, a molding technique method, a stack and bonding method, a micro-machining method, and an interdigital pair boding method.

Among these methods, the interdigital pair boding method is a technique for manufacturing a composite by dicing two piezoelectric member plates with the same kerf width and pitch, aligning the plates such that posts and kerfs of the two plates are intermeshed with each other, and filling a kerf material.

The interdigital pair bonding method is capable of achieving a relatively narrow kerf width among the methods for manufacturing a composite by using a mechanical process, which has an advantage in manufacturing a high-frequency composite, thus providing a merit of achieving a narrow kerf width without using a chemical process such as etching.

However, when there is a misalignment in the interdigital pair boding method, it is hard to obtain a composite of desired performance. Therefore, an alignment process is one of the key processes in the interdigital pair boding method. In practice, however, there is a lack of technology for achieving a precise alignment.

US Pat. Pub. No. 2008/0020153 describes an alignment post and an alignment kerf for manufacturing a composite by the interdigital pair boding method and four ways to form such posts and kerfs. US Pat. Pub. No. 2008/0020153 describes a method for coupling a pair of slabs each having a plurality of posts and a plurality of kerfs by intermeshing the plurality of posts and the plurality of kerfs of the slabs and aligning the slabs by forming at least one of the posts and the kerfs of either one of the slabs as an alignment post or an alignment kerf.

However, in this method, the alignment post or the alignment kerf is located among the plurality of posts or the plurality of kerfs, and hence, in a subsequent step of forming a composite by coupling two piezoelectric materials and then polishing or cutting the composite, a mid portion of the composite needs to be cut. As a result, the process of manufacturing the composite becomes complicated, the manufacturing cost increases, and when there is a misalignment, a high-frequency composite can hardly be obtained.

### DISCLOSURE

### Technical Problem

The present disclosure has been made in view of the above aspects and it is an object of the present disclosure to provide a method for achieving a precise alignment to obtain a composite of desired performance when applying the interdigital pair boding method to manufacture a composite.

### SUMMARY

According to some embodiments of the present disclosure, a method for manufacturing a composite includes, in random order, dicing a first material to provide a first slab having a plurality of posts, at least one alignment post, and a plurality of kerfs, dicing a second material to provide a second slab having a plurality of posts and a plurality of kerfs, coupling the first slab and the second slab in a manner that the first slab and the second slab are intermeshed with each other, and filling a kerf material in between each of the plurality of posts of the first slab and corresponding one of the plurality of posts of the second slab. The at least one alignment post is disposed on both edges or one of the edges of the first slab in a direction along which the plurality of posts and the plurality of kerfs are arranged, and is wider than each of the plurality of posts of the first slab such that the at least one alignment post fits with a corresponding kerf of the second slab.

In addition, according to another embodiment of the present disclosure, a method for manufacturing a composite, comprises, in random order: dicing a first material to provide a first slab having a plurality of posts and a plurality of kerfs; dicing a second material to provide a second slab having a plurality of posts, at least one alignment kerf, and a plurality of kerfs; coupling the first slab and the second slab in a manner that the first slab and the second slab are intermeshed with each other; and filling a kerf material in between each of the plurality of posts of the first slab and corresponding one of the plurality of posts of the second slab, wherein the at least one alignment kerf is disposed on both edges or one of the edges of the second slab in a direction along which the plurality of posts and the plurality of kerfs are arranged, and is narrower than each of the plurality of kerfs of the second slab such that the at least one alignment kerf fits with a corresponding post of the second slab.

According to yet another embodiment of the present disclosure, a method for manufacturing a composite, comprises, in random order: dicing a first material to provide a first slab having a plurality of posts, at least one alignment post, and a plurality of kerfs; dicing a second material to provide a second slab having a plurality of posts, at least one alignment kerf, and a plurality of kerfs; coupling the first slab and the second slab in a manner that the first slab and the second slab are intermeshed with each other; and filling a kerf material in between each of the plurality of posts of the first slab and corresponding one of the plurality of posts of the second slab, wherein the at least one alignment post is disposed on both edges or one of the edges of the first slab in a direction along which the plurality of posts and the plurality of kerfs are arranged, and is wider than each of the plurality of posts of the first slab such that the at least one alignment post fits with a corresponding kerf or the alignment kerf of the second slab, and the at least one alignment kerf is disposed on both edges or one of the edges of the second slab in a direction along which the plurality of posts and the plurality of kerfs are arranged, and is narrower than each of the plurality of kerfs of the second slab such that the at least one alignment kerf fits with a corresponding post or the alignment post of the second slab.

According to yet another embodiment of the present disclosure, a method for manufacturing a composite, comprises, in random order: dicing a first material to provide a first slab having a plurality of posts and a plurality of kerfs; dicing a second material to provide a second slab having a plurality of posts and a plurality of kerfs, the second slab being different from the first slab; coupling the first slab and the second slab in a manner that the first slab and the second slab are intermeshed with each other; and filling a ken material in between each of the plurality of posts of the first slab and corresponding one of the plurality of posts of the second slab, wherein the coupling includes attaching an alignment shim on an outer surface of an outermost post on both edges of one of the edges of the first slab such that the outermost post is inserted with the alignment shim into a corresponding kerf of the second slab.

According to yet another embodiment of the present disclosure, a method for manufacturing a composite, comprises, in random order: dicing a first material to provide a first slab having a plurality of posts and a plurality of kerfs; dicing a second material to provide a second slab having a plurality of posts and a plurality of kerfs, the second slab being different from the first slab; filling a kerf material including a microball for aligning the first slab and the second slab in whole or a part of the plurality of kerfs of the second slab; and coupling the first slab and the second slab in a manner that the first slab and the second slab are intermeshed with each other.

According to yet another embodiment of the present disclosure, a method for manufacturing a composite, comprises, in random order: dicing a first material to provide a first slab having a plurality of posts and a plurality of kerfs; dicing a second material to provide a second slab having a plurality of posts and a plurality of kerfs, the second slab being different from the first slab; aligning the first slab and the second slab after disposing the first slab and the second slab to couple with each other in a manner that the first slab and the second slab are intermeshed with each other; and filling a kerf material in between each of the plurality of posts of the first slab and corresponding one of the plurality of posts of the second slab. Here, the aligning is performed by using an aligning apparatus including a pair of jigs configured to set the first slab and the second slab, a pair of pressurizing units configured to pressurize the pair of jigs, a guide installed in at least one of the pressurizing units and configured to allow at least one of the jigs to slidably move between the pressurizing units, and a microscope for checking a moving distance of the first slab or the second slab between the pressurizing units.

Yet another embodiment of the present disclosure provides a composite manufactured by the aforementioned methods.

### Advantageous Effects

According to some embodiments of the present disclosure, the method for aligning composites in the interdigital pair boding method enables a precise alignment to be achieved, thus enabling a high-frequency composite to be manufactured.

Further, according to some embodiments of the present disclosure, the process of manufacturing a composite can be performed in a simple and easy manner, thus reducing cost and time for manufacturing the composite.

### DESCRIPTION OF DRAWINGS

FIG. 1 is a schematic diagram for illustrating a process of manufacturing a composite by using an interdigital pair bonding method.

FIG. 2 is a schematic diagram for illustrating an alignment method using alignment posts.

FIG. 3 is a schematic diagram for illustrating an alignment method using alignment kerfs.

FIG. 4 is a schematic diagram for illustrating an alignment method using alignment shims.

FIG. 5 is a schematic diagram for illustrating dicing dimensions when performing an alignment by using the alignment shims.

FIG. 6 is a schematic diagram for illustrating a mode in which an alignment shim is used on one side of a first slab and an alignment post is formed on the other side.

FIG. 7 is a schematic diagram for illustrating a method for manufacturing a composite by using alignment posts.

FIG. 8 is a schematic diagram for illustrating a method for manufacturing a composite by using alignment shims.

FIG. 9 is a schematic diagram for illustrating an alignment method using a microball.

FIG. 10 is a schematic diagram for illustrating a method for manufacturing a composite by using the microball.

FIG. 11 is a schematic diagram of an apparatus for aligning a first slab and a second slab.

FIG. 12 is a schematic diagram for illustrating a mode in which a pair of slabs is placed and fixed on a pair of jigs.

FIG. 13 is a schematic diagram for illustrating a mode in which the first slab and the second slab are coupled such that a plurality of posts of the first slab is inserted into a plurality of kerfs of the second slab or a plurality of posts of the second slab is inserted into a plurality of kerfs of the first slab, and a kerf material is filled.

FIG. 14 is a schematic diagram for illustrating a removal of unnecessary portions of the first slab and the second slab and depositing a conductive member.

### DETAILED DESCRIPTION

The following will describe in detail an alignment method and an aligning apparatus 50 in a composite manufacturing process using an interdigital pair bonding method according to some embodiments with reference to the accompanying drawings. The present disclosure can be applied with various modifications and have various modes, and hence specific embodiments are instantiated on the drawings and described in detail in the specification. However, this does not intend to limit the present disclosure to specific embodiments, but should be understood to include all modifications, equivalents, and substitutes within the gist or idea of the disclosure and the technical range of the disclosure. In the following descriptions of the drawings, like reference numerals are assigned to like constituent elements. In the accompanying drawings, dimensions of the elements are magnified for clarity of the present disclosure or downscaled for a better understanding of the overall configuration.

Further, terms including first, second, and the like can be used to describe various constituent elements; however, the constituent elements should not be limited by such terms. The above-mentioned terms are only used to distinguish one constituent element from the other. For example, a first element can be designated as a second element or vice versa without departing from the scope of the present disclosure. In addition, unless otherwise defined in a different manner, all terminologies used in this specification including technical and scientific terms have similar or same meanings as the ones generally understood by a person having ordinary skill in the pertinent art. Terms such as the ones defined in generally-used dictionaries should be construed as having the same meanings as the contextual meanings in the pertinent art, and unless otherwise explicitly defined in the specification, should not be construed in an ideal or excessively formal manner.

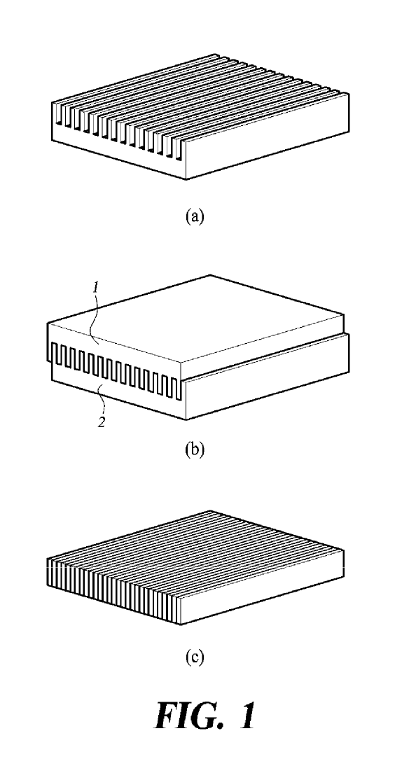

FIG. 1 is a schematic diagram for illustrating a process of manufacturing a composite by using an interdigital pair bonding method. A slab obtained by forming a plurality of posts and a plurality of kerfs on a piezoelectric member by dicing is shown in FIG. 1(a). A post refers to a protrusion of the slab. A kerf refers to a clear space between two adjacent posts. In FIG. 1(b), slabs in a pair are coupled to each other in a manner that the posts of one slab and the posts of the other slab are intermeshed. In other words, it illustrates two slabs coupled to each other in a manner that the posts of one slab are inserted into respective kerfs of the other slab. A composite obtained by removing portions 1 and 2 that are not diced, such that only the posts are left on the two slabs, is shown in FIG. 1(c).

A method for manufacturing a composite by the interdigital pair bonding method includes following steps.

(1) Step of providing a first slab and a second slab each including a plurality of posts and a plurality of kerfs.

Whole or a part of the plurality of posts of the first slab correspond to whole or a part of the plurality of kerfs of the second slab.

(2) Step of coupling the first slab and the second slab in a manner that the plurality of posts of the first slab and the plurality of posts of the second slab are intermeshed with each other.

When applying the interdigital pair bonding method, a width of the kerf is wider than a width of the post. This enables the post of the first slab to be easily inserted into the kerf of the second slab. Similarly, the post of the second slab can be easily inserted into the kerf of the first slab. A space is formed between the posts of the first slab and the posts of the first slab. A width of this space between the posts can be a width of the final kerf of the composite.

(3) Step of moving at least one of the first slab or the second slab while the first slab and the second slab are coupled to each other, such that the posts of the first slab and the posts of the second slab are disposed in parallel at regular intervals.

(4) Step of filling a kerf material 30 in the spaces between the posts of the first slab and the posts of the second slab.

(5) Step of removing portions 1 and 2 that are not diced, leaving the posts of the first slab and the second slab and the kerf material 30.

(6) Step of poling the composite by depositing a conductive member and forming electrodes on top and bottom of the composite in which the plurality of posts of the first slab and the plurality of posts of the second slab are intermeshed each other.

In the present method, the step of aligning the slabs such that the posts of the first slab and the posts of the second slab are disposed in parallel at regular intervals is of great importance. The present disclosure proposes various methods to achieve a precise alignment in manufacturing a composite by the interdigital pair bonding method.

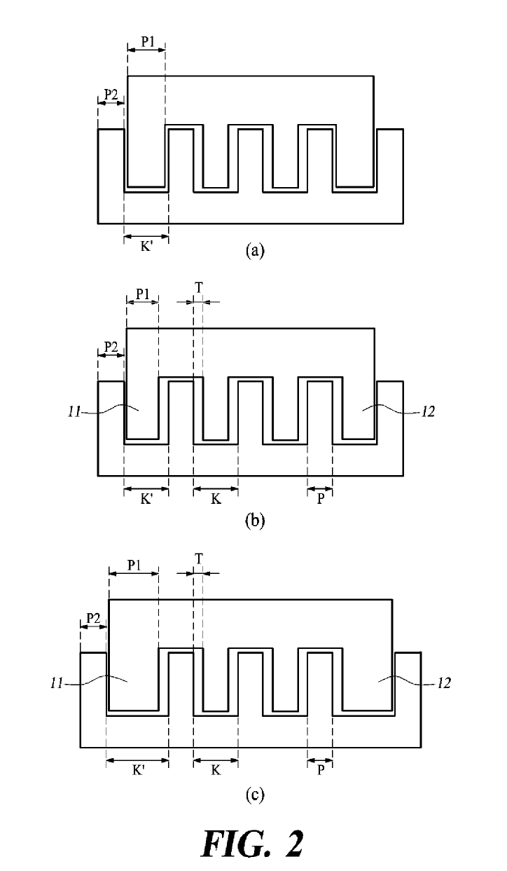

FIG. 2 is a schematic diagram for illustrating an alignment method using alignment posts 11 and 12. A process of manufacturing a composite according to some embodiments provides the alignment method by forming the alignment posts 11 and 12 on at least one side of the first slab.

The alignment posts 11 and 12 are the outermost posts among the plurality of posts formed on the slab, which are formed to cause the plurality of posts of the first slab and the plurality of posts of the second slab to be disposed at regular intervals when the plurality of posts of the first slab and the plurality of posts of the second slab are intermeshed. Two alignment posts 11 and 12 can be formed on both sides of the first slab, or one alignment post can be formed on one side. A case where the alignment posts 11 and 12 are formed on both sides of the first slab is shown in FIG. 2.

The alignment posts 11 and 12 are formed to have a wider width than the other posts. Referring to FIG. 2, the alignment posts 11 and 12 are inserted into the kerfs respectively corresponding to the alignment posts 11 and 12 being in contact with the corresponding kerfs. When the alignment posts 11 and 12 of the first slab are coupled to the corresponding kerfs being in contact with the corresponding kerfs, it is preferred that the width of each of the alignment posts 11 and 12 be slightly narrower than the width of each of the corresponding kerfs into which the alignment posts 11 and 12 are respectively inserted. Alternatively, the alignment post can be inserted into the corresponding kerf with only one side being in contact with the corresponding kerf. A case where both sides are in contact with the kerf is shown in FIG. 2(a), and a case where only one side is in contact with the kerf is shown in FIGS. 2(b) and 2(c).

The subsequent drawings illustrate the case where only one side is in contact with the kerf.

Further, FIGS. 2(b) and 2(c) illustrate dicing dimensions according to some embodiments when the alignment is achieved by using the alignment posts 11 and 12. Referring to FIG. 2, T is a width of the space between the posts, i.e., a final kerf width. K is a width of a kerf. P is a width of the post. P1 is a width of each of the alignment posts 11 and 12. K′ is a width of the kerf into which each of the alignment posts 11 and 12 is inserted. P2 is a width of the post formed on the side of the second slab. In this case, K=T*2+P is satisfied. Further, K′=P1+T is satisfied. As the width P1 of each of the alignment posts 11 and 12 increases, the corresponding width K′ increases by the same amount. K and K′ may be the same, or K′ may be larger than K. A case where K′ and K are the same is shown in FIG. 2(b). A case where K′ is larger than K is shown in FIG. 2(c). When P1 and K′ increase, P2 may decrease. In other words, the width P2 of the outermost post of the second slab may decrease by the amount of the increased width P1 of the alignment post.

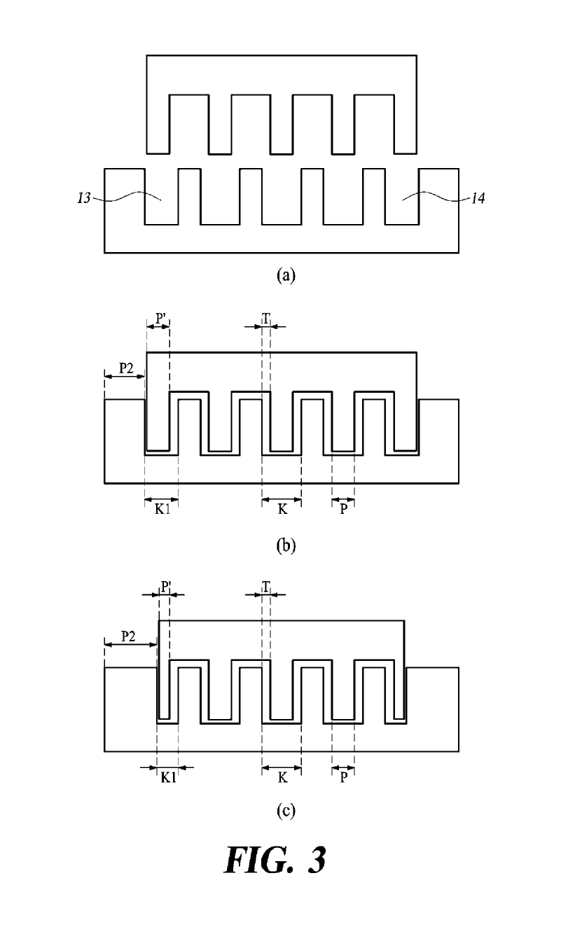

FIG. 3 is a schematic diagram for illustrating an alignment method using alignment kerfs 13 and 14. A method for manufacturing a composite according to some embodiments of the present disclosure provides an alignment method using alignment kerfs 13 and 14 formed on both edges or one of the edges of the second slab.

The alignment kerfs 13 and 14 are kerfs positioned on the outermost side among the plurality of kerfs formed on the slab, and in a similar manner to the alignment posts 11 and 12, allow the plurality of posts of the first slab and the plurality of posts of the second slab to be disposed at regular intervals when coupling the first slab and the second slab in an intermeshed manner. Two alignment kerfs 13 and 14 may be formed on both edges of the second slab, or one of the alignment kerfs 13 and 14 may be formed on one of the edges. In the example shown in FIG. 3, the alignment kerfs 13 and 14 are formed on both edges of the second slab.

The alignment kerfs 13 and 14 are formed to have narrower widths than the other kerfs. Although not shown in the drawings, the alignment kerfs 13 and 14 may be coupled with both sides in contact with the posts corresponding to the alignment kerfs 13 and 14 (not shown), or may be coupled with only one sides in contact with the corresponding posts. In the example shown in FIG. 3, only one sides of the alignment kerfs 13 and 14 are contact with the corresponding posts.

FIG. 3(a) illustrates the first slab and the second slab before the first slab is coupled with the second slab where the alignment kerfs are formed. FIGS. 3(b) and 3(c) illustrate dicing dimensions in some embodiments when the alignment is achieved with the alignment kerfs 13 and 14.

Referring to FIG. 3, the posts formed on both edges of the second slab have wider widths than the other posts. Instead, the alignment kerfs 13 and 14 formed on both edges of the second slab have narrower widths. As a result, outer surfaces of the two outermost posts of the first slab are brought into contact with inner surfaces of the alignment kerfs of the second slab, thus both slabs are coupled with each other in an intermeshed manner.

Referring to FIG. 3(b), T is a width of a space between the posts, i.e., a final kerf width. K is a width of the kerf. P is a width of the post. K1 is a width of each of the alignment kerfs 13 and 14. P′ is a width of the post inserted into each of the alignment kerfs 13 and 14. P2 is a width of the post formed on the edge of the second slab. In this case, K=T*2+P is satisfied. Further, K1=P′+T is satisfied. When the width K1 of each of the alignment kerfs 13 and 14 is decreased, the width P′ of the corresponding post is decreased accordingly. P and P′ may be the same, or P′ may be narrower. FIG. 3(b) illustrates a case where P′ and P are the same. FIG. 3(c) illustrates a case where P′ is narrower than P. When K1 and P′ are decreased, P2 may be increased. In other words, the width P2 of the outermost post of the second slab may be increased by the same amount as the decreased width K1 of the alignment kerf.

Alternatively to the aforementioned case where the alignment post is formed on the first slab or the case where the alignment kerf is formed on the second slab, the alignment post can be formed on the first slab and the alignment kerf is formed on the second slab, so that the alignment is achieved by inserting the alignment post of the first slab into the alignment kerf of the second slab. Further, the alignment can be achieved by inserting the alignment post into the kerf on one side of the composite and inserting the alignment kerf onto the post on the other side.

The first slab may be formed by dicing a first material in one direction. The second slab may be formed by dicing a second material in one direction. The dicing can be performed by using a tool such as a dicing saw.

The first material and the second material are formed with lengths of width/height/depth larger than the dimension of the final composite. By doing this, a composite can be polished into the required dimension. At least one of the first material or the second material may be piezoelectric material. A PZT or a single crystal may be used as the piezoelectric material.

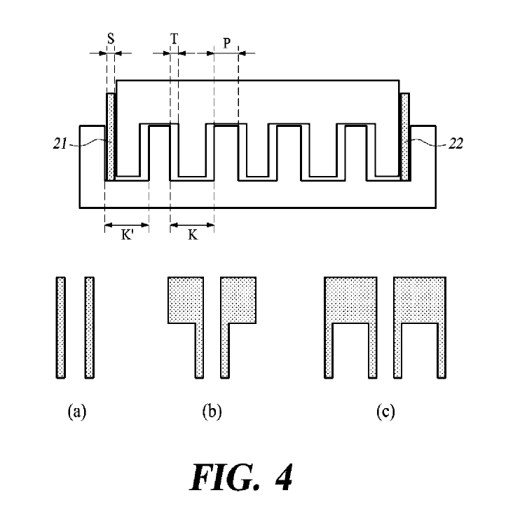

FIG. 4 is a schematic diagram for illustrating an alignment method using alignment shims 21 and 22. Referring to FIG. 4, alignment shims 21 and 22 are respectively attached to outer surfaces of the outermost posts on both edges or one of the edges of the first slab, such that the first slab and the second slab are coupled in an intermeshed manner by the outermost posts being inserted with the alignment shims 21 and 22 into the kerfs of the second slab respectively corresponding to the outermost posts in the step of coupling the first slab and the second step.

A piezoelectric element or a material such as epoxy can be used for the alignment shims 21 and 22, but not limited to such element or material. The alignment shims 21 and 22 need to be attached until the composite is manufactured, and hence the alignment shims 21 and 22 are one-time use members. A magnitude of the height of each of the alignment shims 21 and 22 can be larger or smaller than a magnitude of the thickness of the first slab; however, if a pressure is applied for kerf filling and curing, it is preferred that the former be smaller than the latter. A shape of each of the alignment shims 21 and 22 includes any one of a line shape (FIG. 4(a)), an L shape (FIG. 4(b)), and a recessed U shape (FIG. 4(c)) as shown in FIG. 4, and further includes various shapes other than the above-mentioned shapes.

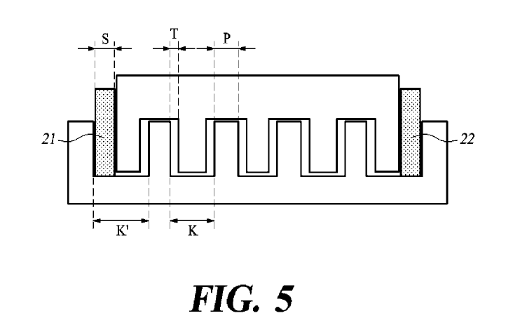

FIGS. 4 and 5 illustrate dicing dimensions according to some embodiments when the alignment is achieved by using the alignment shims 21 and 22. Referring to FIG. 4, T is a width of a space between the posts (which will be the final kerf width of the composite). K is a width of the kerf. P is a width of the post. S is a width of each of the alignment shims 21 and 22. In this case, K=T*2+P is satisfied. Further, K′=S+P+T is satisfied. When the width S of each of the alignment shims 21 and 22 is increased, the width K′ of the corresponding kerf is increased accordingly. K and K′ may be the same, or K′ may be wider. A case where K′ and K are the same is shown in FIG. 4. A case where K′ is wider than K is shown in FIG. 5.

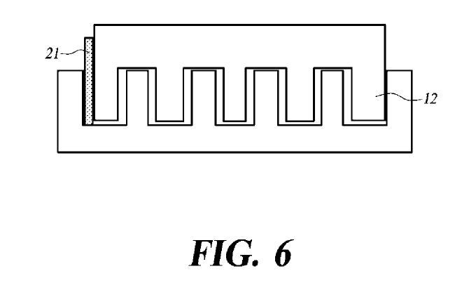

FIG. 6 is a schematic diagram for illustrating a mode in which the alignment shim 21 is used on one side of the first slab and the alignment post 12 is formed on the other side. An alignment method using both the alignment shim 21 and the alignment post 12 is also possible as shown in FIG. 6.

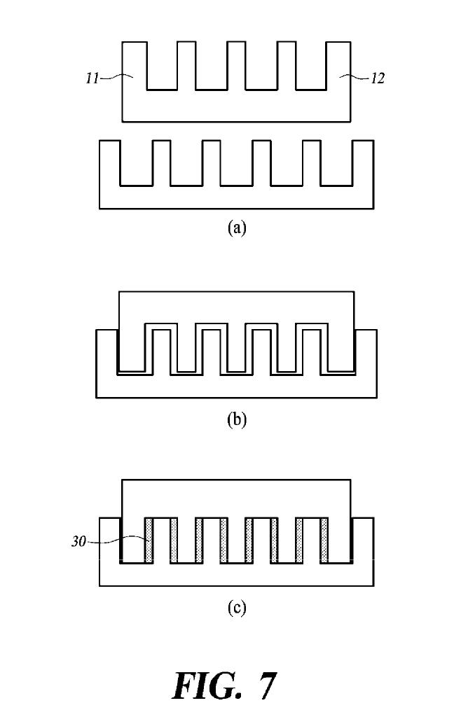

FIG. 7 is a schematic diagram for illustrating a method for manufacturing a composite by using the alignment posts 11 and 12. Referring to FIG. 7, a method for manufacturing a composite by using the alignment posts 11 and 12 includes a step of providing a first slab having a plurality of posts, a plurality of kerfs, and the alignment posts 11 and 12 each having wider width than the plurality of posts and a second slab having a plurality of posts and a plurality of kerfs (FIG. 7(a)), a step of coupling the first slab and the second slab in a manner that the outer surfaces of the alignment posts 11 and 12 of the first slab are brought into contact with the inner surfaces of the respective outermost posts of the second slab (FIG. 7(b)), and a step of filling the kerf material 30 in each space between the posts of the first slab and the posts of the second slab (FIG. 7(c)).

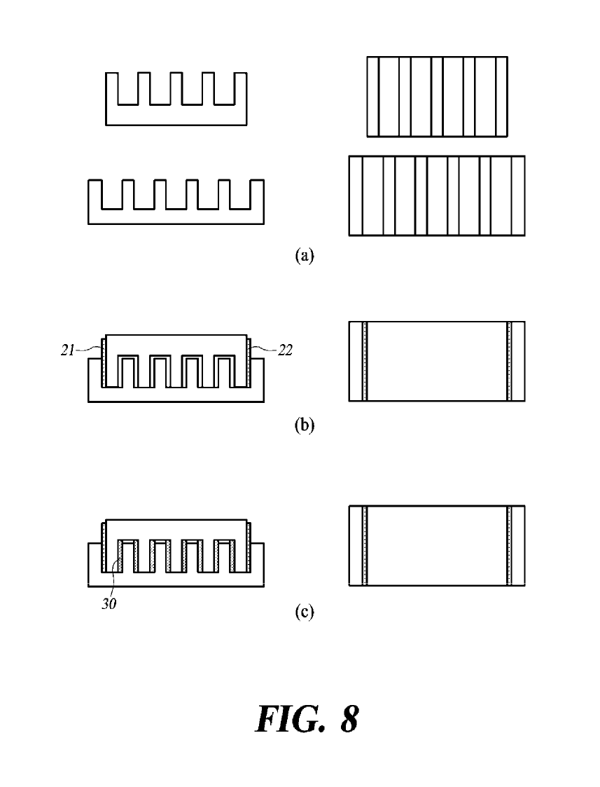

FIG. 8 is a schematic diagram for illustrating a method for manufacturing a composite by using the alignment shims 21 and 22. In FIG. 8, the left figure is a side view, and the right figure is a plan view. Referring to FIG. 8, a method for manufacturing a composite by using the alignment shims 21 and 22 includes a step of providing a first slab having a plurality of posts and a plurality of kerfs and a second slab having a plurality of posts and a plurality of kerfs (FIG. 8(a)), a step of coupling the first slab and the second slab by attaching the alignment shims 21 and 22 on the respective outer surfaces of the first slab, such that the alignment shims 21 and 22 and the outermost posts of the first slab are inserted into the kerfs on both edges of the second slab in an intermeshed manner (FIG. 8(b)), and a step of filling the kerf material 30 in a space between the posts of the first slab and the posts of the second slab (FIG. 8(c)).

Both the alignment methods by using the alignment posts 11 and 12 and by using the alignment shims 21 and 22 further include a step of determining alignment criteria including required widths of the plurality of posts of the first slab and the second slab and the required widths of the plurality of kerfs of the first slab and the second slab (the alignment criteria may include the widths of the alignment posts 11 and 12 and the widths of the alignment shims 21 and 22), i.e., alignment criteria for the posts of the first slab and the posts of the second slab to maintain the regular intervals, and the first slab and the second slab can be manufactured by dicing the first material and the second material based on the alignment criteria.

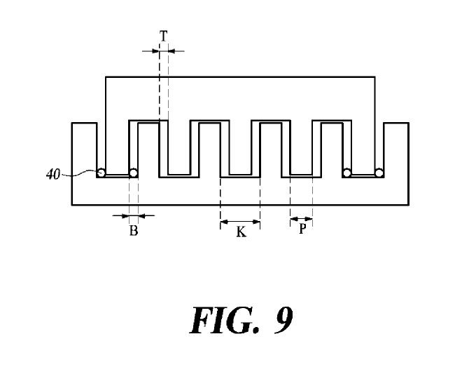

FIG. 9 is a schematic diagram for illustrating an alignment method using a microball 40. Referring to FIG. 9, the alignment can be achieved by disposing a microball 40 having a diameter corresponding to the final kerf width in the kerf of the second slab. The microball 40 may be disposed in the whole or a part of the kerfs of the second slab. The microball 40 may include a piezoelectric element or various materials such as epoxy and metal. Using a number of microballs 40, even when there is an error in the diameter of a part of the microballs 40, a precise final kerf width can be obtained.

FIG. 9 illustrates dicing dimensions in some embodiments when the alignment is achieved with the microball 40. Referring to FIG. 9, T is a width of a space between the posts (which will be the final kerf width of the composite). K is a width of the kerf. P is a width of the post. B is a diameter of the microball 40. In this case, K=T*2+P is satisfied. Further, as B=T, K=B*2+P, i.e., B=(K−P)/2 is satisfied.

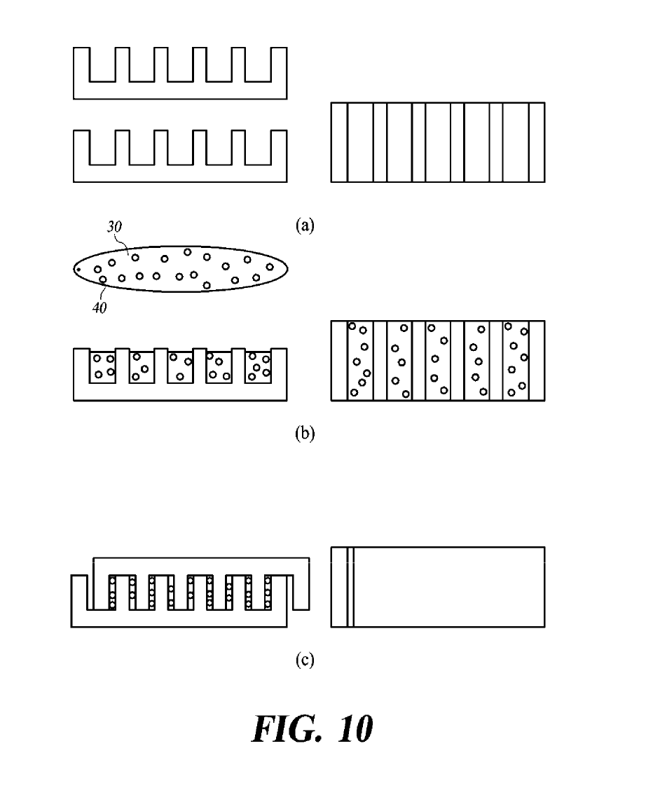

FIG. 10 is a schematic diagram for illustrating an alignment method using the microball 40. In FIG. 10, the left figure is a side view, and the right figure is a plan view. Referring to FIG. 10, a method for manufacturing a composite by using the microball 40 includes a step of providing a first slab having a plurality of posts and a plurality of kerfs and a second slab having a plurality of posts and a plurality of kerfs (FIG. 10(a)), a step of filling a mixture of the kerf material 30 and the microball 40, and a step of coupling the first slab and the second slab in a manner that the plurality of posts of the first slab is inserted into the plurality of kerfs of the second slab or the plurality of posts of the second slab is inserted into the plurality of kerfs of the first slab (FIG. 10(c)). If the microball 40 and the kerf material 30 are different from each other when mixing the kerf material 30 and the microball 40, it is preferred to add a small amount of the microball 40 in order to maintain the characteristics of the kerf material 30.

The first material and the second material may be the same, or may be different from each other. When the first material and the second material are the same material, by filling the kerf material 30 that is different from the first material and the second material, which will be described later, a composite having two types of components can be obtained. When the first material and the second material are different from each other, by filling the kerf material 30 that is different from the first material and the second material, a composite having three types of components can be obtained.

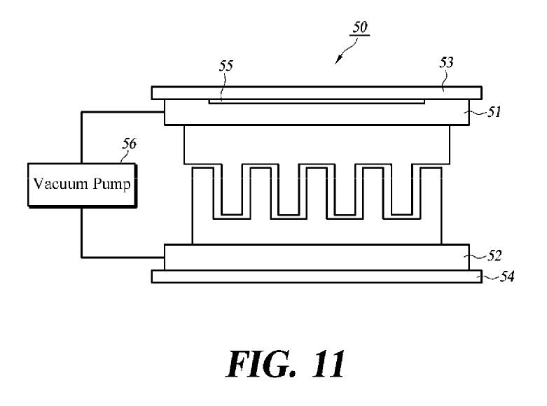

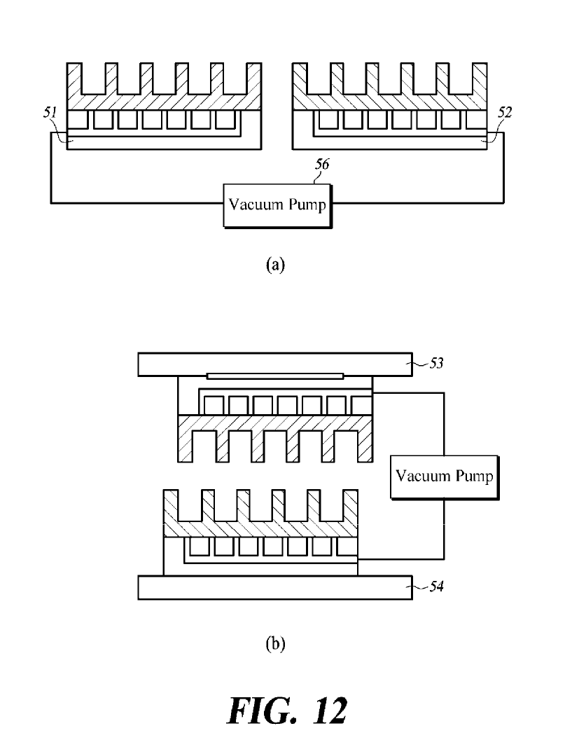

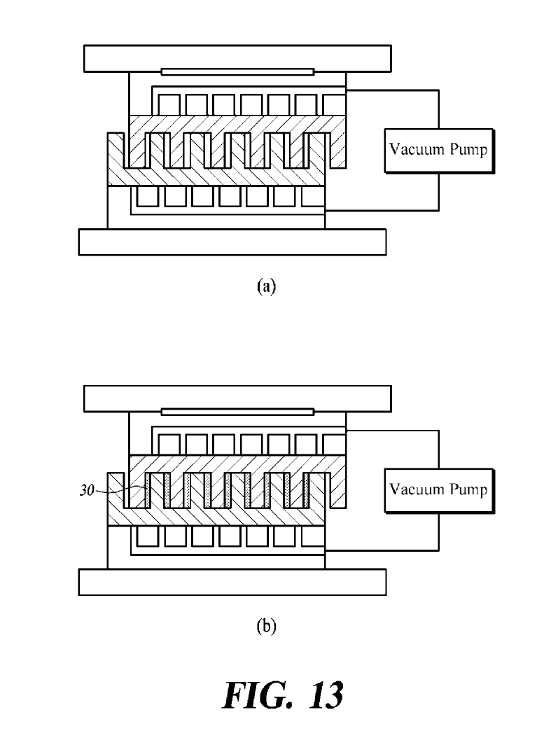

FIG. 11 is a schematic diagram of an aligning apparatus 50 for aligning the first slab and the second slab, such that the plurality of posts of the first slab and the plurality of posts of the second slab maintain the required interval therebetween. FIG. 12 is a schematic diagram for illustrating a mode in which a pair of slabs is placed and set on a pair of jigs 51 and 52. FIG. 13 is a schematic diagram for illustrating a mode in which the first slab and the second slab are coupled such that the plurality of posts of the first slab is inserted into the plurality of kerfs of the second slab or the plurality of posts of the second slab is inserted into the plurality of kerfs of the first slab, and the kerf material 30 is filled.

The aligning apparatus 50 may include a pair of jigs 51 and 52 that sets the first slab and the second slab, a pair of pressurizing units 53, and 54 that pressurizes the pair of jigs 51 and 52, a guide 55 installed in at least one of the pressurizing units 53 and 54 and that allows at least one of the jigs 51 and 52 to slidably move between the pressuring units 53 and 54, and a microscope for checking a moving distance of the first slab or the second slab between the pressurizing units 53 54. A vacuum pump 56 can be connected to the jigs 51 and 52, such that the slabs can be set through the vacuum pump 56.

An alignment method using the aligning apparatus 50 sets the first slab and the second slab on the jigs 51 and 52 by placing the first slab and the second slab on the jigs 51 and 52, respectively, and connecting the vacuum pump 56. The jigs 51 and 52 are attached to the pressurizing units 53 and 54. At this time, the vacuum pump 56 is turned on until the filling and curing of the kerf is completed. The pressurizing unit is then placed on the microscope, and the focus is adjusted such that the first slab and the second slab are visible. By sliding the first slab or the second slab while slightly pressurizing the pressurizing units 53 and 54 until the final kerf width becomes constant, to adjust and align position of the second slab with respect to the first slab or position of the first slab with respect to the second slab. By pressurizing in the above manner, the first slab or the second slab is prevented from deforming at the time of aligning the slabs. Thereafter, the pressurizing units 53 and 54 pressurize the jigs 51 and 52, thus bringing the top of the post and the bottom of the kerf into contact with each other. By pressurizing in the above manner, an unnecessary layer of the kerf material 30 is prevented from being generated. A micrometer can be used in order to move the jigs 51 and 52 within the pressurizing units 53 and 54 in a fine manner.

After performing the alignment by using the four alignment methods described above, a step of filling and curing the kerf material 30 is performed. However, the step of aligning the slabs can be performed after the step of filling the kerf material 30. The kerf material 30 can be filled by using a vacuum chamber, and the curing of the kerf material can be performed by using an oven. Materials for the kerf material 30 include polymer, epoxy, and the like. A step of removing an internal bubble can be performed to remove the internal bubble at the time of filling the kerf material. The step of removing the internal bubble can be performed by using a vacuum chamber. The whole material can be pressurized in order to prevent a deformation of the material at the time of filling and curing the kerf material 30.

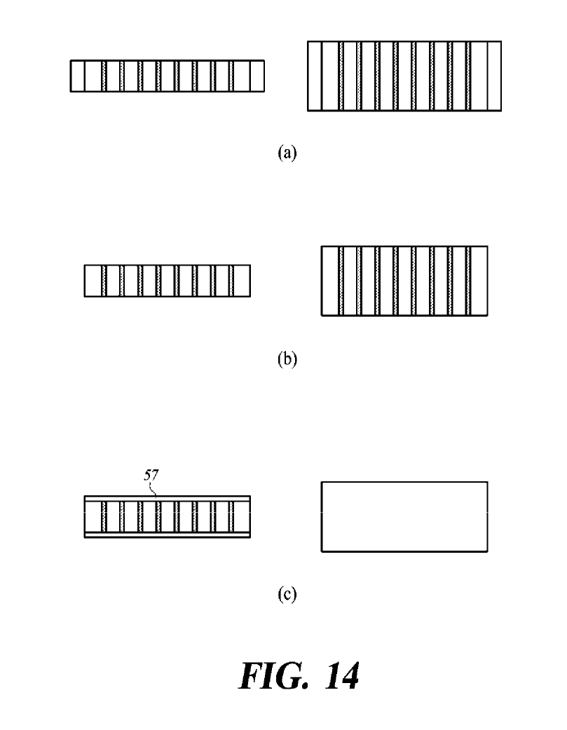

FIG. 14 is a schematic diagram for illustrating a removal of unnecessary portions of the first slab and the second slab and depositing a conductive member 57. In FIG. 14, the left figure is a side view, and the right figure is a plan view. FIG. 14(a) illustrates the composite with an undiced portion removed, leaving only the posts of the first slab and the second slab. FIG. 14(b) illustrates the composite with unnecessary side portions removed from the first slab and the second slab. FIG. 14(c) illustrates a deposition of a conductive member on surfaces of the first slab and the second slab by forming an electrode and performing a poling.

When the step of filling and curing the kerf material 30 is completed, the undiced portion and the side portions of the first slab and the second slab where the alignment posts 11 and 12 are formed or the alignment shims 21 and 22 are coupled are lapped by using a lapping machine or a grinding machine or cut by using a dicing saw, leaving only the posts of the first slab and the second slab. At this time, the lapping can be performed until a desired thickness of the composite is obtained simultaneously with the removal of the unnecessary portions. Thereafter, a step of depositing the conductive member and the step of performing a poling to form the electrode on the composite can be performed by depositing conductive material such as gold on top and bottom of the composite by using thermal evaporation or sputtering.

Although exemplary embodiments of the present disclosure have been described for illustrative purposes, those skilled in the art will appreciate that various modifications, additions, and substitutions are possible, without departing from the essential characteristics of the disclosure.

### REFERENCE NUMERALS

11, 12: alignment post
21, 22: alignment shim
30: kerf material
40: microball
50: aligning apparatus

1. A method for manufacturing a composite, the method comprising, in random order:
dicing a first material to provide a first slab having a plurality of posts, at least one alignment post, and a plurality of kerfs;
dicing a second material to provide a second slab having a plurality of posts and a plurality of kerfs;
coupling the first slab and the second slab in a manner that the first slab and the second slab are intermeshed with each other; and
filling a kerf material in between each of the plurality of posts of the first slab and corresponding one of the plurality of posts of the second slab, wherein
the at least one alignment post is disposed on both edges or one of the edges of the first slab in a direction along which the plurality of posts and the plurality of kerfs are arranged, and is wider than each of the plurality of posts of the first slab such that the at least one alignment post fits with a corresponding kerf of the second slab.

2. A method for manufacturing a composite, the method comprising, in random order:
dicing a first material to provide a first slab having a plurality of posts and a plurality of kerfs;
dicing a second material to provide a second slab having a plurality of posts, at least one alignment kerf, and a plurality of kerfs;
coupling the first slab and the second slab in a manner that the first slab and the second slab are intermeshed with each other; and
filling a kerf material in between each of the plurality of posts of the first slab and corresponding one of the plurality of posts of the second slab, wherein
the at least one alignment kerf is disposed on both edges or one of the edges of the second slab in a direction along which the plurality of posts and the plurality of kerfs are arranged, and is narrower than each of the plurality of kerfs of the second slab such that the at least one alignment kerf fits with a corresponding post of the second slab.

3. A method for manufacturing a composite, the method comprising, in random order:
dicing a first material to provide a first slab having a plurality of posts, at least one alignment post, and a plurality of kerfs;
dicing a second material to provide a second slab having a plurality of posts, at least one alignment kerf, and a plurality of kerfs;
coupling the first slab and the second slab in a manner that the first slab and the second slab are intermeshed with each other; and
filling a kerf material in between each of the plurality of posts of the first slab and corresponding one of the plurality of posts of the second slab, wherein
the at least one alignment post is disposed on both edges or one of the edges of the first slab in a direction along which the plurality of posts and the plurality of kerfs are arranged, and is wider than each of the plurality of posts of the first slab such that the at least one alignment post fits with a corresponding kerf or the alignment kerf of the second slab, and
the at least one alignment kerf is disposed on both edges or one of the edges of the second slab in a direction along which the plurality of posts and the plurality of kerfs are arranged, and is narrower than each of the plurality of kerfs of the second slab such that the at least one alignment kerf fits with a corresponding post or the alignment post of the second slab.

4. A method for manufacturing a composite, the method comprising, in random order:
dicing a first material to provide a first slab having a plurality of posts and a plurality of kerfs;
dicing a second material to provide a second slab having a plurality of posts and a plurality of kerfs, the second slab being different from the first slab;
coupling the first slab and the second slab in a manner that the first slab and the second slab are intermeshed with each other; and
filling a kerf material in between each of the plurality of posts of the first slab and corresponding one of the plurality of posts of the second slab, wherein
the coupling includes attaching an alignment shim on an outer surface of an outermost post on both edges of one of the edges of the first slab such that the outermost post is inserted with the alignment shim into a corresponding kerf of the second slab.

5. The method according to claim 4, wherein a magnitude of height of the alignment shim is smaller than a magnitude of thickness of the first slab.

6. The method according to claim 4, wherein a shape of the alignment shim includes an L shape or a recessed U shape.

7. A method for manufacturing a composite, the method comprising, in random order:
dicing a first material to provide a first slab having a plurality of posts and a plurality of kerfs;
dicing a second material to provide a second slab having a plurality of posts and a plurality of kerfs, the second slab being different from the first slab;
filling a kerf material including a microball for aligning the first slab and the second slab in whole or a part of the plurality of kerfs of the second slab; and
coupling the first slab and the second slab in a manner that the first slab and the second slab are intermeshed with each other.

8. The method according to claim 7, wherein a diameter of the microball is equal to or smaller than a width of a final kerf.

9. A method for manufacturing a composite, the method comprising, in random order:
dicing a first material to provide a first slab having a plurality of posts and a plurality of kerfs;
dicing a second material to provide a second slab having a plurality of posts and a plurality of kerfs, the second slab being different from the first slab;
aligning the first slab and the second slab after disposing the first slab and the second slab to couple with each other in a manner that the first slab and the second slab are intermeshed with each other; and
filling a kerf material in between each of the plurality of posts of the first slab and corresponding one of the plurality of posts of the second slab, wherein
the aligning is performed by using an aligning apparatus including
a pair of jigs configured to set the first slab and the second slab,
a pair of pressurizing units configured to pressurize the pair of jigs,
a guide installed in at least one of the pressurizing units and configured to allow at least one of the jigs to slidably move between the pressurizing units, and
a microscope for checking a moving distance of the first slab or the second slab between the pressurizing units.

10. The method according to any one of claims 1 to 9, wherein at least one of the first material or the second material includes piezoelectric material.

11. The method according to any one of claims 1 to 9, wherein the kerf material includes polymer or epoxy.

12. The method according to any one of claims 1 to 9, wherein the filling includes removing an internal bubble.

13. The method according to any one of claims 1 to 9, further comprising curing the kerf material after the filling.

14. The method according to claim 13, wherein the filling and the curing are performed while pressuring whole of the first slab and the second slab in order to prevent the first slab and the second slab from deforming.

15. The method according to one of claims 1 to 9, further comprising removing a portion that is not diced and a side portion, leaving only the posts of the first slab and the second slab.

16. The method according to claim 15, wherein the removing is performed by using a lapping machine or a grinding machine.

17. The method according to claim 15, further comprising performing a poling, after the removing, including
depositing a conductive member on top and bottom of the composite, and
forming an electrode on the composite.

18. An apparatus for aligning a first slab having a plurality of posts and a plurality of kerfs and a second slab having a plurality of posts and a plurality of kerfs after disposing the first slab and the second slab in a manner that the first slab and the second slab are coupled by being intermeshed with each other, the apparatus comprising:
a pair of jigs configured to set the first slab and the second slab;
a pair of pressurizing units configured to pressurize the pair of jigs;
a guide installed in at least one of the pressurizing units and configured to allow at least one of the jigs to slidably move between the pressuring units; and
a microscope for checking a moving distance of the first slab or the second slab between the pressurizing units.

19. The apparatus according to claim 18, wherein at least one of the jigs includes a micrometer for measuring the moving distance of the first slab or the second slab between the pressuring units.

20. The apparatus according to claim 18, wherein the jigs are configured to set the first slab and the second slab by using a vacuum pump.

21. A composite manufactured by the method according to any one of claims 1 to 9.
